(19) United States
(12) Patent Application Publication
(10) Pub. No.: US 2026/0149363 A1
(43) Pub. Date: May 28, 2026

(54) IMPROVED SHORT-CIRCUIT-PROTECTED CONVERTER ASSEMBLY

(71) Applicant: SMA Solar Technology AG, Niestetal (DE)

(72) Inventors: Alexander Unru, Baunatal (DE); Mohamed Khshainy, Kassel (DE); Marcel Kratochvil, Kassel (DE)

(21) Appl. No.: 19/453,041

(22) Filed: Jan. 20, 2026

Related U.S. Application Data
(63) Continuation of application No. PCT/EP2024/071898, filed on Aug. 1, 2024.

(30) Foreign Application Priority Data
Sep. 1, 2023 (DE) 10 2023 123 634.2

(51) Int. Cl. H02M 1/32; H02M 1/12; H02M 7/487; H02M 7/493

(52) U.S. Cl. CPC H02M 1/325; H02M 1/123; H02M 1/126; H02M 7/487; H02M 7/493

(57) ABSTRACT

The disclosure relates to a converter assembly for transmitting electric power between phases of a three-phase or multi-phase network and a DC bus. The converter assembly includes a DC/AC converter which can be connected to the network via a sine filter and to the DC bus via a split DC-side intermediate circuit, wherein a converter bridge of the DC/AC converter is connected to a central point (M) of the intermediate circuit, and a rectifier is connected in parallel with the DC/AC converter. The DC/AC converter has a controller which is configured to operate the DC/AC converter in an over-modulation mode if the voltage values of the DC bus are less than double the amplitude of one of the phase voltages of the network.

### REFERENCE TO RELATED APPLICATIONS

This application is a Continuation of International Application number PCT/EP2024/071898, filed on Aug. 1, 2024, which claims the benefit of German Application number 10 2023 123 634.2, filed on Sep. 1, 2023. The contents of the above-referenced Patent Applications are hereby incorporated by reference in their entirety.

### FIELD

The disclosure relates to a converter assembly for transmitting electric power between phases of a three-phase or multi-phase grid and a DC bus.

### BACKGROUND

To supply DC loads connected to a DC bus from an AC grid (DC=direct current; AC=alternating current), DC/AC converters are used that extract electric power from the AC grid and supply it to the DC bus in order to maintain a DC bus voltage within a permissible range for its operation. A reverse power flow from the DC bus to the AC grid—for example, if DC sources and/or storage devices are connected to the DC bus in addition to the DC loads—may also be required or desired for this purpose, whereby the term “DC/AC converter” also comprises such converters in the following. DC/AC converters typically comprise a converter bridge in which half-bridges with series-connected semiconductor power switches, each with an antiparallel freewheeling diode, are arranged between a positive DC voltage terminal and a negative DC voltage terminal, between which a bridge output is located that is connected to a phase of the AC grid via a sine filter, also known as a grid filter. The freewheeling diodes, considered in isolation, form a rectifier, so that in case the DC bus connected to the DC voltage terminals has too low a DC bus voltage, an uncontrollable current flows through the freewheeling diodes, which can destroy or at least damage the converter bridge. Such a case occurs, for example, in the event of a short circuit on the DC bus.

To protect against such damage to the converter bridge of the DC/AC converter, it was proposed in document DE 10 2021 113 205 A1 to connect a passive rectifier in parallel with the DC/AC converter, which rectifier is intended to take over the short-circuit current instead of the DC/AC converter. In order to ensure that the rectifier becomes conductive at a higher threshold than the DC/AC converter, and thus effectively protect it, it was proposed to connect a transformer with a boosting transformation ratio upstream of the rectifier on the AC side, so that the rectifier is subjected to a higher grid amplitude on the AC side than the DC/AC converter. However, such a transformer represents a considerable additional expense.

Furthermore, the use of such a rectifier as a short-circuit protection limits the operation of the DC bus at DC bus voltages at which none of the rectifier diodes become conductive, because then an uncontrolled current arises in the phase of the AC grid connected to the conducting diode, which can suddenly assume very high values due to the low grid impedance. In any case, such an uncontrolled current impairs the grid quality, as it contains significant non-grid frequency components. This is already the case with DC loads having central-point-grounded interference suppression capacitors when the bus voltage falls below double the amplitude of one of the phase voltages of the AC grid connected to the rectifier. It is therefore recommended for the aforementioned system design that the DC bus voltage maintains a minimum distance from the maximum permissible value of double the amplitude of the phase voltage.

Furthermore, for pure feed-in systems, the use of over-modulation is known, for example, from document EP 2 375 552 A1, to allow a standard-compliant feed-in of power from a DC source into a grid even at a voltage of the DC source that is below double the amplitude of the phase voltage of the grid.

### SUMMARY

Accordingly, an object of this disclosure is to provide a converter assembly for transmitting electric power between phases of a three-phase or multi-phase grid and a DC bus, in which assembly a passive rectifier is connected in parallel with an active DC/AC converter as short-circuit protection, and to allow safe operation in this arrangement with an extended DC voltage range, which can be extended below double the amplitude of one of the phase voltages of the grid.

In one embodiment of the disclosure, a converter assembly for transmitting electric power between phases of a three-phase or multi-phase grid and a DC bus comprises a DC/AC converter to be connected to the grid via a sine filter and to the DC bus via a split DC-side intermediate circuit, wherein a converter bridge of the DC/AC converter is connected to a central point of the intermediate circuit. Furthermore, the converter assembly comprises a rectifier connected in parallel with the DC/AC converter. The DC/AC converter has a controller configured to operate the DC/AC converter in over-modulation mode if the voltage values of the DC bus voltage are less than double the amplitude of one of the phase voltages of the grid. In this process, the central point of the intermediate circuit, and thus the potentials of a positive and a negative terminal of the intermediate circuit, or the positive and negative potential of a connected DC bus, are shifted so that the positive DC bus potential is greater than the highest current phase potential of the AC grid and at the same time the negative DC bus potential is smaller than the lowest phase potential of the AC grid. Consequently, even for DC bus voltages less than double the amplitude of the phase voltage of the AC grid, an uncontrolled current through one of the diodes of the rectifier can be avoided by operating the DC/AC converter in over-modulation mode, at least within a limited voltage range.

In this way, the generation of a fault current through the recharging of interference suppression capacitors connected to the DC bus is accepted. Because this fault current flows through the DC/AC converter, its amplitude and its higher frequency components are greatly reduced by the sine filter of the DC/AC converter compared to the case where one of the diodes of the rectifier connected in parallel becomes conductive, because a fault current occurring in this case bypasses the DC/AC converter and is therefore not dampened by the sine filter.

Due to operating-condition-related voltage drops across the sine filter during operation of the DC/AC converter, it is advantageous in one embodiment to shift the potential of the central point of the intermediate circuit so that a suitably chosen minimum distance between the positive or negative bus potential and the highest or lowest phase potential of the AC grid is maintained at all times. This can be achieved through flat-top modulation, increasing operational reliability and improving the EMC (electromagnetic compatibility) behavior of the converter assembly. At the same time, the fault current generated by over-modulation is reduced.

The over-modulation can be generated in one embodiment by exciting a zero system with three times the grid frequency, such that the central point of the intermediate circuit is shifted sinusoidally. However, other forms of over-modulation with different potential shift time profiles are also conceivable, which ensure that there is always a sufficient distance between the positive or negative bus potential and the highest or lowest phase potential of the AC grid. For example, the central point potential can only be shifted by the smallest amount required to ensure the minimum distance.

Another advantage of using over-modulation is that the switching losses of the converter bridge can be reduced by decreasing the number of switching operations during over-modulation compared to an operation without overmodulation. The converter assembly can therefore be operated energy-efficiently in the extended voltage range.

It should be noted at this point that operating the DC/AC converter in over-modulation mode generates a capacitive fault current that has three times the grid frequency. However, this fault current has a lesser impact on grid quality than the uncontrolled current through the rectifier diodes.

In an advantageous embodiment, the fault current generated by the over-modulation is at least disregarded when monitoring the fault current of the converter assembly by means of a fault current monitoring unit or circuit, or is actively compensated for in the detection of the fault current. This can be achieved, for example, by an additional conductor which, alongside the phase conductors and the neutral conductor, is routed through a fault current sensor of the fault current monitoring system and through which a suitably generated compensation current flows. It is also conceivable to correct the signal of the fault current sensor by the known fault current component generated by the over-modulation before evaluation of the fault current signal. In an advantageous embodiment, a frequency component of the fault current at three times the grid frequency is not taken into account at all when assessing whether a fault current event is present, or is eliminated from the signal before assessment.

### BRIEF DESCRIPTION OF THE FIGURES

The invention is illustrated below with reference to the figures, in which:

FIG. 1 shows an embodiment of a converter assembly according to the disclosure,

FIG. 2 shows a course of voltages and ground currents without over-modulation over time,

FIG. 3 shows a course of voltages with a first type of over-modulation over time, and

FIG. 4 shows a course of voltages with a second type of over-modulation over time.

### DETAILED DESCRIPTION

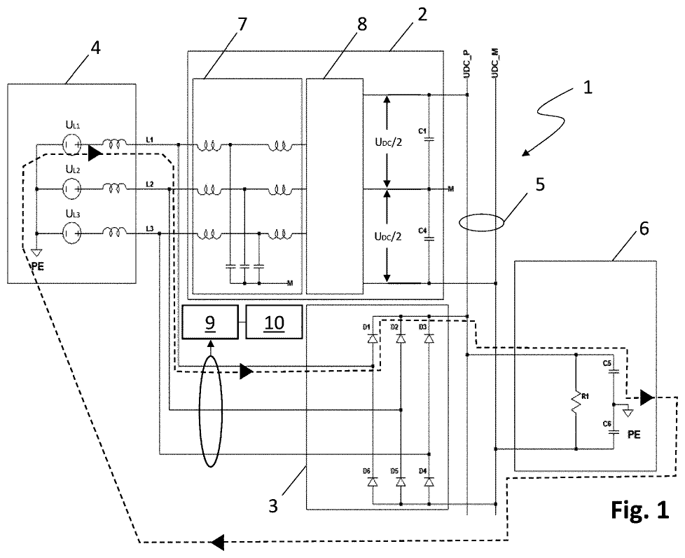

FIG. 1 shows an embodiment of a converter assembly 1 according to the invention comprising a DC/AC converter 2 and a rectifier 3, which are connected to a three-phase grid 4 at a common terminal point. The grid 4 provides phase voltages UL1, UL2, UL3 assigned at each terminal point of the converter assembly 1 with phases L1, L2, L3, the phase voltages having the same amplitude aligned symmetrically with a ground potential PE.

The DC/AC converter 2 has on the grid side a sine filter 7 to which a converter bridge 8 is connected in order to exchange power in both directions between the grid 4 and a DC bus 5 connected to a DC terminal of the DC/AC converter 2. Between the converter bridge 2 and the DC bus 5, a split intermediate circuit is arranged with a first intermediate circuit capacitor C1 and a second intermediate circuit capacitor C2, which are connected in series via a central point M. In normal operation, the voltage UDC of the DC bus 5 is divided equally between the intermediate circuit capacitors C1 and C2. The voltage distribution can be changed in a known manner by controlling bridge switches of the converter bridge 2 and thus regulated according to requirements.

Connected to the DC bus 5 is a load 6, which is symbolized by a load resistor R1 and comprises series-connected interference suppression capacitors C5 and C6 to improve electromagnetic compatibility. The central point of the interference suppression capacitors C5, C6 is connected to ground PE. Additional loads, which may optionally also comprise interference suppression capacitors as well as additional power supplies, such as battery converters, can be connected to the DC bus 5.

The voltage on the DC bus 5 depends on the current operating conditions and can therefore fluctuate within a permissible voltage range or even leave this range, for example, due to undesirable operating conditions. For example, a fault in the form of a short circuit or an impermissibly high temporary power draw may occur, as a result of which the voltage UDC of the DC bus 5 drops below the rectified mean value of the phase voltages UL1, UL2, UL3 of the grid 4. In this case, the rectifier 3 is intended to generate a current flow from the grid 4 into the DC bus 5 which bypasses the DC/AC converter 2 and is sufficient to trigger fuses provided in the DC bus 5. This measure prevents damage or destruction of the bridge switches of the converter bridge 8 connected in an anti-parallel manner or of freewheeling diodes integrated into it.

However, if the voltage UDC of the DC bus 5 approaches the rectified mean value of the grid 4, and the positive potential UDC_P relative to ground PE becomes slightly smaller than a current value of a phase voltage UL1, UL2, UL3 of the grid 4 relative to ground, or the negative potential UDC_M relative to ground PE becomes slightly larger than a current value of a phase voltage UL1, UL2, UL3 of the grid 4 relative to ground, then one of the diodes of the rectifier 3 switches to a conducting state and triggers a current flow, which, for example, is shown in FIG. 1 as a dashed line starting from diode D1 of the rectifier 3 via interference suppression capacitor C5 to ground PE and from there via phase L1 back to diode D1. To detect a fault current, a fault current monitoring unit or circuit 9 can be provided in the converter assembly 1. The fault current monitoring unit or circuit 9 can be communicatively connected to a controller 10 (e.g., a control circuit) of the converter assembly 1.

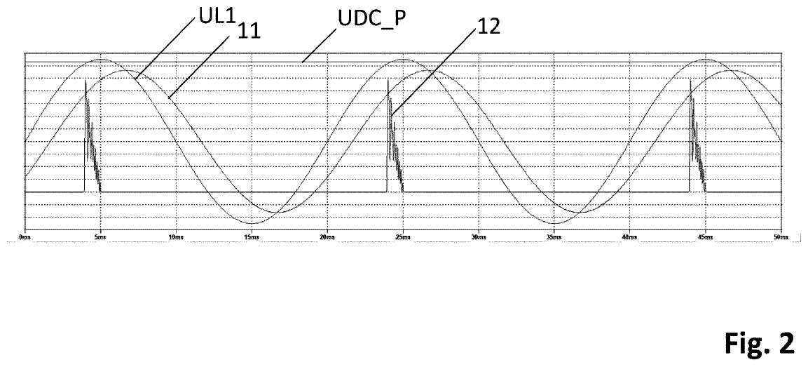

FIG. 2 shows a measured course over time of one of the phase voltages of the grid, here by way of example the phase voltage UL1, of the voltage 11 of the same phase between the sine filter 7 and the converter bridge 8, of the fault current 12 which flows through a selected rectifier diode (here diode D1 of FIG. 1) and through ground PE, and a value of the positive DC bus potential UDC_P. It can be seen that at the instant when the phase voltage UL1 exceeds the value of the positive DC bus potential UDC_P, a peak value of the fault current 12 is generated, which subsides when the phase voltage UL1 reaches its peak value. The maximum value of the fault current 12 is substantially limited in one embodiment by the level of the grid impedance of the affected phase. However, this does not necessarily trigger the fuses of the DC bus 5 if the exceedance is only temporary. Still, because the current peak exhibits impermissibly high frequency components above the grid frequency and thus degrades the grid quality, operating the converter assembly 1 under these conditions violates standards for grid connection. In addition, when the phase voltage UL1, UL2, UL3 exceeds or falls below one of the DC bus potentials UDC_P, UDC_M, a comparable current peak is generated via the other diodes of the rectifier, so that in a three-phase grid up to six current peaks can occur during one grid period and impair the grid quality. Such a converter assembly 1 would therefore have to be taken out of service if a minimum distance between the positive or negative DC bus potential and one of the phase voltages is not maintained, which limits the permissible voltage range.

In addition to the fault current described above, which can also be understood and described as the generation of a zero system by the rectifier 3, a deviating zero system generated by the DC/AC converter 2 can cause a circulating current that flows between the DC/AC converter 2 and the rectifier 3 and leads at least to losses and heating of the current-carrying components. This circulating current can significantly exceed the fault current and also shorten the service life of the converter assembly 1, but it is not effective for the grid quality, at least not directly.

Protecting the DC/AC converter 2 via a parallel rectifier therefore leads, without the use of a converter assembly 1 according to the disclosure, to the disadvantage that the lower limit of the permissible voltage range for the DC bus 5 must be higher by a safety margin than the rectified mean value of the grid voltage. This disadvantage is overcome by the converter assembly 1 according to the disclosure in such a way that the converter assembly 1 can also be operated at voltage values UDC of the DC bus 5 that are lower than the rectified mean value of the grid 4, thereby reliably preventing the adverse effect on the grid quality described above.

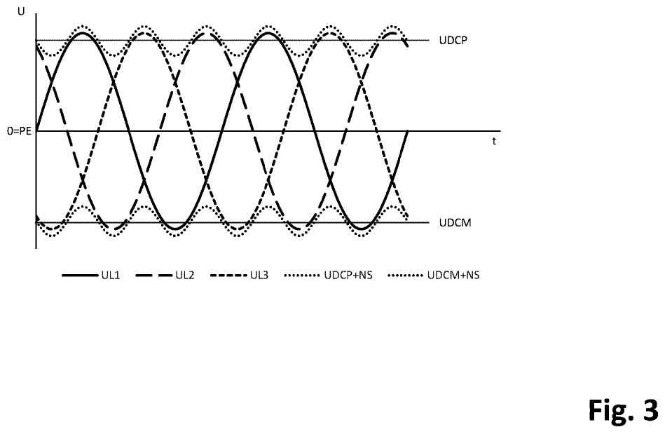

FIG. 3 shows a first variant of an over-modulation of the converter assembly 1 according to the disclosure. The time profiles of the phase voltages UL1, UL2, UL3 are shown in comparison to the mean positive DC bus potential UDCP and the mean negative DC bus potential UDCM, respectively, on which a common sinusoidal potential shift in the form of a zero system NS with three times the grid frequency is superimposed, so that the superimposed positive DC bus potential UDCP+NS is always higher and the superimposed negative DC bus potential UDCM+NS is always lower than any of the phase voltages UL1, UL2, UL3. This ensures that the diodes of rectifier 3 remain blocked even when the phase voltages exceed or fall below the limits given by the mean DC bus potentials UDCP and UDCM, respectively. Although the superimposition of the DC bus potentials with a zero system, designated as UDCP+NS, UDCM+NS, also causes a fault current through the recharging of the interference suppression capacitors C5, C6 connected to the DC bus 5, this has a much lower amplitude than the fault current 12 in the case described in FIG. 2 and furthermore has only a frequency component at three times the grid frequency without higher frequency components. This affects the grid quality far less, and the fault current caused by the over-modulation can be easily compensated for in a previously known manner via the fault current during the insulation monitoring of the DC bus 5.

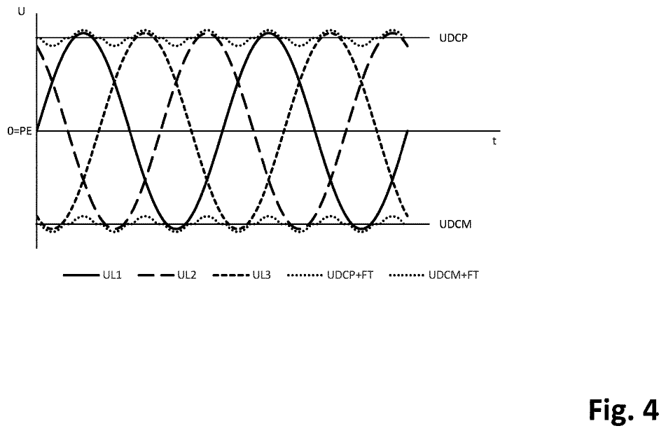

FIG. 4 shows a second variant of an over-modulation of the converter assembly 1 according to the disclosure. The time profiles of the phase voltages UL1, UL2, UL3 are also shown here in comparison to the mean positive DC bus potential UDCP and the mean negative DC bus potential UDCM, respectively, on which a common potential shift in the form of a flat-top modulation FT with three times the grid frequency is superimposed, so that the superimposed positive DC bus potential UDCP+FT is always higher and the superimposed negative DC bus potential UDCM+FT is always lower than any of the phase voltages UL1, UL2, UL3. Specifically, in flat-top modulation, the DC bus potentials UDCP+FT, UDCM+FT are kept at the values of the mean DC bus potentials UDCP, UDCM if the mean DC bus potentials UDCP, UDCM have a distance to all phase voltages UL1, UL2, UL3 that is greater than a specified minimum distance, and otherwise shifted so that the specified minimum distance is maintained. In other words, the minimum shift of the DC bus potentials UDCP+FT, UDCM+FT is applied which is required to maintain the specified minimum distance. This minimizes the amount of fault current caused, but the fault current then also has frequency components that are a multiple of three times the grid frequency.

Other forms of over-modulation with different time profiles of the shift of the DC bus potentials are also conceivable without departing from the technical teaching according to the disclosure.

What is claimed is:

1. A converter assembly for transmitting electric power between phases of a three-phase or multi-phase grid and a DC bus, comprising:
a DC/AC converter configured to be connected to the three-phase or multi-phase grid via a sine filter and to the DC bus via a split DC-side intermediate circuit, and comprising a converter bridge of the DC/AC converter connected to a central point of the split DC-side intermediate circuit, and
a rectifier connected in parallel with the DC/AC converter,
wherein the DC/AC converter further comprises a controller configured to operate the DC/AC converter in an over-modulation mode when voltage values of the DC bus are less than double an amplitude of one phase voltage of the three-phase or multi-phase grid.

2. The converter assembly according to claim 1, wherein the rectifier is connected in parallel with the DC/AC converter without a transformer.

3. The converter assembly according to claim 1, wherein the converter assembly further comprises a fault current monitoring unit or circuit, wherein the fault current monitoring unit or circuit is configured to disregard or compensate for a fault current caused by an over-modulation during a monitoring of the fault current.

4. The converter assembly according to claim 1, wherein the converter assembly comprises a fault current monitoring unit or circuit, wherein the fault current monitoring unit or circuit is configured to disregard a frequency component of a fault current when the fault current is at three times the grid frequency during the monitoring of the fault current.

5. The converter assembly according to claim 1, wherein the over-modulation is configured such that a positive DC bus potential to ground is at any time during a full cycle period of the grid voltage greater than a maximum phase voltage of the three-phase or multi-phase grid to ground and a negative DC bus potential to ground is at any time during a full cycle period of the grid voltage less than a minimum phase voltage of the three-phase or multi-phase grid to ground.

6. The converter assembly according to claim 1, wherein the over-modulation is a sinusoidal shift of the DC bus potentials relative to ground.

7. The converter assembly according to claim 1, wherein the over-modulation is a flat-top modulation of the DC bus potentials relative to ground.
